(19) United States
(12) Patent Application Publication
(10) Pub. No.: US 2016/0204427 A1
(43) Pub. Date: Jul. 14, 2016

(54) Solid-State Batteries and Methods for Fabrication

(71) Applicants: IMEC VZW, Leuven (BE); Katholieke Universiteit Leuven, KU LEUVEN R&D, Leuven (BE)

(72) Inventors: Philippe Vereecken, Luik (BE); Cedric Huyghebaert, Leuven (BE); Xubin Chen, Yong'An (CN)

(73) Assignees: IMEC VZW, Leuven (BE); Katholieke Universiteit Leuven, KU LEUVEN R&D, Leuven (BE)

(21) Appl. No.: 14/992,873

(22) Filed: Jan. 11, 2016

(30) Foreign Application Priority Data
Jan. 12, 2015 (EP) 15150848.8

(51) Int. Cl. H01M 4/36; H01M 10/0585

(52) U.S. Cl. CPC H01M 4/366; H01M 10/0585; H01M 2004/021

(57) ABSTRACT

Composite electrodes are disclosed that comprise an active electrode material and a solid electrolyte, wherein the solid electrolyte is a composite electrolyte. The composite electrolyte comprises an electrically insulating material having a plurality of pores and a solid electrolyte material covering inner surfaces of the plurality of pores. The active electrode material may comprise a plurality of active electrode material particles in electrical contact with each other, and the composite electrolyte may be located in spaces between the plurality of active electrode material particles. The present disclosure is further related to solid-state batteries comprising a stack of an anode, a solid electrolyte layer, and a cathode, wherein at least one of the anode and the cathode is a composite electrode according to the present disclosure. The present disclosure further provides methods for fabricating such composite electrodes and solid-state batteries.

### CROSS-REFERENCE TO RELATED APPLICATION

The present application is a non-provisional patent application claiming priority to European Patent Application No. 15150848.8 filed on Jan. 12, 2015, the contents of which are hereby incorporated by reference

### FIELD

The present disclosure is related to all-solid-state batteries comprising composite components and to methods for fabricating such all-solid-state batteries.

The present disclosure is further related to composite electrodes and to methods for fabricating such composite electrodes.

### BACKGROUND

All-solid-state ceramic battery cells comprising a solid inorganic electrolyte are known. In a fabrication process for such battery cells, a solid electrolyte powder is mixed with an active electrode material in order to realize a large interface between the active electrode material and the electrolyte. When using an inorganic oxide electrolyte material, a sintering step at a high temperature, e.g. at a temperature exceeding 500° C., is needed to weld the materials together, and to form a composite electrode with paths for ionic transport and charge conduction.

Instead of oxide electrolyte materials, softer sulfide materials may be used. Such materials can be pressed together more easily and a much lower thermal budget is needed to form a composite electrode. However, these materials are very reactive and difficult to handle. Further, they pose potential safety issues, as gaseous and poisonous H₂S may be formed as an undesired by-product, e.g. when overcharging a battery.

Requirements for the solid electrolyte of an all-solid-state battery cell include a high ion conductivity (e.g. higher than 10⁻³ S/cm), negligible electric conductivity (e.g. lower than 10⁻¹⁰ S/cm), and chemical stability. Composite electrolytes have been proposed as a solution to combine good ion conductivity with chemical stability. Composite electrolytes are materials composed of a metal salt and an inert material, such as an oxide, acting as a host structure for the metal ions. In such composite electrolytes, ionic conduction mainly occurs via interfaces between the metal salt and the inert material.

Powder based methods are known for fabricating such inorganic composite electrolytes. Inorganic composite electrolytes may, for example, be made by mixing a Li-salt with inert oxide particles, followed by sintering. In addition, the use of micro-porous particles has been reported, wherein the salt covers the pore walls inside the particles.

A problem related to particle based or powder based inorganic composite electrolytes is the poor ionic conduction from particle to particle. For example, in case of a composite electrolyte comprising oxide particles coated with a Li salt, a higher ion conductance is achieved at the interface between the Li salt and the inert oxide surface. Therefore, a higher surface area (corresponding to smaller particles) would in principle lead to a higher ion conductivity. However, as the ion conduction further proceeds through the bulk of the poorly conducting Li salt interconnecting the particles, smaller particles lead to more connections between particles and thus a lower ion conductivity.

### SUMMARY

The present disclosure aims to provide composite electrolytes and composite electrodes having a good ion conductivity, for example higher than 10⁻⁴ S/cm, preferably higher than 10⁻³ S/cm. The present disclosure further aims to provide batteries comprising such composite electrodes.

The present disclosure aims to provide solid-state battery cells comprising a composite electrolyte and at least one composite electrode, wherein the composite electrolyte and the at least one composite electrode have a good ion conductivity, for example higher than 10⁻⁴ S/cm, preferably higher than 10⁻³ S/cm. The present disclosure further aims to provide batteries comprising such battery cells.

The present disclosure aims to provide methods for the fabrication of composite electrodes with a good ion conductivity (e.g. exceeding 10⁻⁴ S/cm), wherein the fabrication methods can be performed at temperatures not exceeding 500° C.

The present disclosure aims to provide methods for the fabrication of composite electrodes with a good ion conductivity (e.g. exceeding 10⁻⁴ S/cm), wherein the fabrication methods are compatible with roll-to-roll processing.

The present disclosure aims to provide methods for the fabrication of solid-state battery cells and solid-state batteries comprising a composite electrolyte with a good ion conductivity (e.g. exceeding 10⁻⁴ S/cm, preferably exceeding 10⁻³ S/cm), and comprising at least one composite electrode with a good ion conductivity (e.g. exceeding 10⁻⁴ S/cm, preferably exceeding 10⁻³ S/cm). The fabrication methods can be performed at temperatures not exceeding 500° C.

The present disclosure aims to provide methods for the fabrication of solid-state battery cells and solid-state batteries comprising a composite electrolyte with a good ion conductivity (e.g. exceeding 10⁻⁴ S/cm, preferably exceeding 10⁻³ S/cm) and comprising at least one composite electrode with a good ion conductivity (e.g. exceeding 10⁻⁴ S/cm, preferably exceeding 10⁻³ S/cm), wherein the fabrication methods are compatible with roll-to-roll processing.

The present disclosure is related to composite electrodes comprising an active electrode material and a solid electrolyte, wherein the solid electrolyte is a composite electrolyte. The composite electrolyte may comprise an electrically insulating material having a plurality of pores, and a solid electrolyte material covering inner surfaces of the plurality of pores.

In embodiments of the present disclosure, the solid electrolyte material covering inner surfaces of the plurality of pores may be an inorganic electrolyte material, e.g. comprising a salt, such as a Li salt or Li-ion salt.

In embodiments of the present disclosure, the solid electrolyte material covering inner surfaces of the plurality of pores may be a polymer electrolyte material comprising an insulating polymer as a host and a salt, such as a Li salt or Li-ion salt.

In embodiments of the present disclosure, the active electrode material may comprise a plurality of active electrode material particles in electrical contact with each other, and the composite electrolyte may be located in spaces between the plurality of active electrode material particles.

A composite electrode of the present disclosure may further comprise other elements, such as an electrically conductive additive and/or a binder.

The present disclosure is further related to a solid-state battery comprising a stack of an anode, a solid electrolyte layer, and a cathode, wherein at least one of the anode or the cathode is a composite electrode according to the present disclosure.

The solid electrolyte layer may comprise a composite electrolyte comprising an electrically insulating material having a plurality of pores, and a solid electrolyte material covering inner surfaces of the plurality of pores.

The composite electrode and the solid electrolyte layer may comprise substantially the same composite electrolyte.

The solid-state battery according to the present disclosure may further comprise a first current collector in electrical contact with the anode, and a second current collector in electrical contact with the cathode.

The present disclosure further relates to a method for fabricating a composite electrode, wherein the method comprises: preparing an electrode slurry comprising a plurality of active electrode material particles and an electrically conductive additive; coating the electrode slurry on a substrate; and drying the electrode slurry, thereby forming an electrode coating. The method also comprises: compressing the electrode coating, thereby forming a compressed electrode coating; providing a liquid or viscous glass precursor in the compressed electrode coating; and performing a heat treatment, thereby transforming the glass precursor into a solid porous electrically insulating material comprising a plurality of pores.

Drying the electrode slurry may comprise heating to a temperature in the range between 70° C. and 150° C., the present disclosure not being limited thereto.

Performing the heat treatment for transforming the glass precursor into a solid porous electrically insulating material comprising a plurality of pores may comprise heating to a temperature in the range between 150° C. and 500° C., the present disclosure not being limited thereto.

In embodiments of the present disclosure, providing the liquid or viscous glass precursor in the compressed electrode coating may comprise providing the glass precursor in the electrode slurry, for example, mixing the glass precursor with the electrode slurry, before coating the electrode slurry on the substrate.

In embodiments of the present disclosure, providing the liquid or viscous glass precursor in the compressed electrode coating may comprise: coating the glass precursor on the compressed electrode coating; and allowing the glass precursor to penetrate into the compressed electrode coating, thereby filling spaces between the plurality of active electrode material particles.

In embodiments of the present disclosure, the method for fabricating a composite electrode further comprises providing a solid electrolyte material covering inner walls or inner surfaces of the plurality of pores of the solid porous electrically insulating material. Providing the solid electrolyte material may comprise: filling the plurality of pores of the porous electrically insulating material at least partially with a liquid electrolyte material; and performing a drying step, thereby forming a solid electrolyte material covering inner walls or inner surfaces of the plurality of pores. Alternatively, providing the solid electrolyte material may comprise coating the electrolyte material on the inner walls or inner surfaces of the plurality of pores, for example using a vapor-based process such as CVD (Chemical Vapor Deposition), e.g. ALD (Atomic Layer Deposition).

In alternative embodiments of the present disclosure, the method for fabricating a composite electrode comprises mixing the glass precursor with a liquid electrolyte material before performing the heat treatment.

The present disclosure further relates to methods for fabricating a solid-state battery. A method for fabricating a solid-state battery according to the present disclosure comprises: forming on a first substrate a compressed anode coating comprising at least a plurality of active anode material particles, an electrically conductive additive and a first glass precursor; forming on a second substrate a compressed cathode coating comprising at least a plurality of active cathode material particles, an electrically conductive additive, and a second glass precursor; and providing a third glass precursor on at least one of the anode coating or the cathode coating. The method also comprises: drying the third glass precursor at a temperature in the range between 70° C. and 150° C., thereby forming a glass layer having a predetermined thickness; afterwards heating the compressed anode coating, the compressed cathode coating and the glass layer to a temperature in the range between 150° C. and 500° C., thereby transforming the first glass precursor, the second glass precursor and the glass layer into solid porous materials comprising a plurality of pores; and providing a solid electrolyte material covering inner walls or inner surfaces of the plurality of pores of the solid porous materials, thereby forming a composite cathode, a composite electrolyte layer and a composite anode.

Providing the solid electrolyte material may comprise: filling the plurality of pores of the porous electrically insulating material at least partially with a liquid electrolyte material; and performing a drying step, thereby forming a solid electrolyte material covering inner walls or inner surfaces of the plurality of pores. Alternatively, providing the solid electrolyte material may comprise coating the electrolyte material on the inner walls or inner surfaces of the plurality of pores, for example, using a vapor-based method such as CVD (Chemical Vapor Deposition), e.g. ALD (Atomic Layer Deposition).

In embodiments of the present disclosure, the method for fabricating a solid-state battery further comprises laminating the first substrate comprising the composite anode to the second substrate comprising the composite cathode, thereby forming a stack of a composite anode, a composite electrolyte layer, and a composite cathode.

In alternative embodiments of the present disclosure, providing the third glass precursor may comprise providing the third glass precursor on the compressed cathode coating, and forming the compressed anode coating on the first substrate may comprise forming the compressed anode coating on the glass layer.

Certain objects and advantages of various inventive aspects have been described herein above. Of course, it is to be understood that not necessarily all such objects or advantages may be achieved in accordance with any particular embodiment of the disclosure. Thus, for example, those skilled in the art will recognize that the disclosure may be embodied or carried out in a manner that achieves or optimizes one advantage or group of advantages as taught herein without necessarily achieving other objects or advantages as may be taught or suggested herein. Further, it is understood that this summary is merely an example and is not intended to limit the scope of the disclosure. The disclosure, both as to organization and method of operation, together with features and advantages thereof, may best be understood by reference to the following detailed description when read in conjunction with the accompanying drawings.

### BRIEF DESCRIPTION OF THE FIGURES

FIG. 1 schematically shows a solid-state battery in accordance with an embodiment of the present disclosure.

FIG. 2 schematically shows a solid-state battery in accordance with an embodiment of the present disclosure.

FIG. 3 illustrates an example of a method that may be used for fabricating a composite electrode according to the present disclosure.

FIG. 4 illustrates an example of a method that may be used for fabricating a composite electrode according to the present disclosure.

FIG. 5 schematically shows an example of a process flow that may be used for fabricating a solid-state battery according to the present disclosure.

FIG. 6 schematically shows an example of a process flow that may be used for fabricating a solid-state battery according to the present disclosure.

Any reference signs in the claims shall not be construed as limiting the scope of the present disclosure. In the different drawings, the same reference signs refer to the same or analogous elements.

### DETAILED DESCRIPTION

In the following detailed description, numerous specific details are set forth in order to provide a thorough understanding of the disclosure and how it may be practiced in particular embodiments. However, it will be understood that the present disclosure may be practiced without these specific details. In other instances, well-known methods, procedures and techniques have not been described in detail, so as not to obscure the present disclosure.

The present disclosure will be described with respect to particular embodiments and with reference to certain drawings but the disclosure is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the disclosure.

Furthermore, the terms first, second, third, and the like in the description and in the claims, are used for distinguishing between similar elements and not necessarily for describing a sequential or chronological order. The terms are interchangeable under appropriate circumstances and the embodiments of the disclosure can operate in other sequences than described or illustrated herein.

Moreover, the terms top, bottom, over, under, and the like in the description and the claims are used for descriptive purposes and not necessarily for describing relative positions. It is to be understood that the terms so used are interchangeable under appropriate circumstances and that the embodiments of the disclosure described herein are capable of operation in other orientations than described or illustrated herein.

The term “comprising,” used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B.

In a rechargeable battery, the electrode that is the negative electrode in discharge (i.e. battery operation) becomes the positive electrode when charging the battery. Generally, anode material and cathode material as used herein refer to the materials that are the anode (negative electrode) and, respectively, the cathode (positive electrode) during battery operation or discharge. Through the disclosure, when referred to “anode material” it is meant the negative electrode material, and when referred to “cathode material” it is meant the positive electrode material.

The present disclosure relates to a composite electrode, e.g. for use in an all-solid-state battery cell, wherein the composite electrode comprises a mixture of an active electrode material and a solid composite electrolyte. The active electrode material comprises a plurality of active electrode material particles in electrical contact with each other and a composite electrolyte in spaces between the plurality of active electrode material particles. The composite electrolyte comprises an electrically insulating material having a plurality of pores and a solid electrolyte material covering inners surfaces of the plurality of pores. The composite electrode may further comprise electrically conductive additives and/or a binding agent, for example.

The present disclosure further relates to a solid-state battery cell comprising a stack of an anode, a solid electrolyte layer, and a cathode, wherein at least one of the anode or the cathode is a composite electrode in accordance with the present disclosure. The solid electrolyte layer comprises a composite electrolyte containing an electrically insulating material having a plurality of pores, and a solid electrolyte material covering inner surfaces of the plurality of pores. The electrolyte layer is in electrical and ionic contact with the anode and the cathode.

The solid-state battery cell may further comprise a first current collector in electrical contact with the anode and a second current collector in electrical contact with the cathode.

In embodiments of the present disclosure, the porous electrically insulating material (further also referred to as porous glass) may for example consist of porous silica, porous alumina or porous alumina silicates. It may contain any porous dielectric material that can be formed, e.g. casted, from a viscous or liquid solution. For example, the porous electrically insulating material may be formed by a sol-gel process, e.g. using a metal precursor (e.g. TEOS: Si(OC₂H₅)₄), a solvent mixture (e.g. water and ethanol), an acid (e.g. HNO₃, HCl) or a base (e.g. NH₄OH) catalyst and a surfactant.

The porosity of the electrically insulating material or glass may for example be in the range between 5% and 50%, the present disclosure not being limited thereto. The pore size (characterized by the pore diameter) may for example be in the range between 0.4 nm and 50 nm, the present disclosure not being limited thereto.

In the further description, the present disclosure is mainly described for Li-ion batteries, but the present disclosure is not limited thereto. For example, the present disclosure also relates to other battery types based on ion insertion, such as for example Mg batteries or Mg-ion batteries.

In embodiments of the present disclosure, the electrolyte material may for example be an inorganic electrolyte material. For example, in case of a Li-ion battery, the inorganic electrolyte material may comprise a Li-ion salt, such as LiTaO₃, LiAl₂O₄, Li₂SiO₃, Li₂ZnI₄, LiNO₃, LiPO₃, Li₃PO₄, LiH₂PO₄, Li₂HPO₄, Li₂SO₄, Li₂CO₃, LiHCO₃, Li₂O, LiOH, LiI, or LiClO₄, the present disclosure not being limited thereto.

Alternatively, in embodiments of the present disclosure the electrolyte material may for example be a polymer electrolyte material comprising a salt and an insulating polymer as a host for the salt (e.g. Li-ion salt). Illustrative examples of insulating polymers that may be used as a host are Poly-ethylene oxide (PEO), poly-propylene oxide (PPO), Poly-phenylene oxide (PPO), polyoxyphenylenes, (POP), poly(methyl methacralate) PMMA, Poly(acrylonitrile) (PAN), or Poly(ethylene glycol) diacrylate (PEGDA).

For a Li-ion battery, the active electrode material of the anode may for example comprise Li, graphite, silicon, germanium, tin (Sn) or Ti, the present disclosure not being limited thereto. For example, Li₄Ti₅O₁₂ may be used as an active electrode material for the anode. The active electrode material of the cathode may for example comprise LiCoO₂, MnO₂, LiMn₂O₄, LiFePO₄, LiNiO₂, or V₂O₅, the present disclosure not being limited thereto.

As an electrically conductive additive to increase the electric conductivity of the cathode material or of the anode material, for example carbon black, carbon nanotubes or graphene may be used, the present disclosure not being limited thereto. Poly Vinylidene Fluoride (PVDF), PolyVinyl Alcohol (PVA), or Styrene Butadiene Rubber (SBR) may for example be used as a binding agent, the present disclosure not being limited thereto.

The first current collector may for example comprise Cu or Ni, the present disclosure not being limited thereto.

The second current collector may for example comprise Al or C, the present disclosure not being limited thereto.

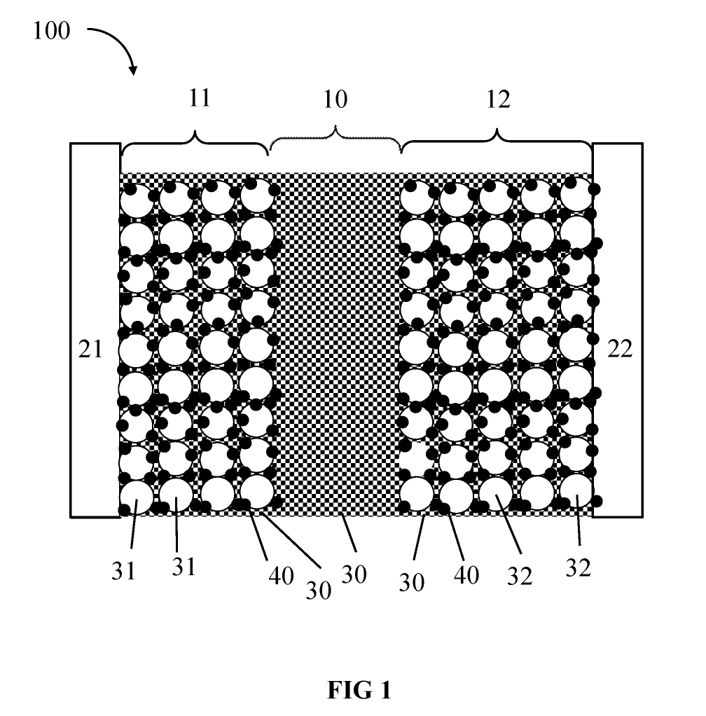

FIG. 1 schematically shows a solid-state battery 100 in accordance with an embodiment of the present disclosure. The solid-state battery 100 comprises a stack of an anode 11, a solid electrolyte layer 10, and a cathode 12. The solid-state battery 100 further comprises a first current collector 21 in electrical contact with the anode 11, and a second current collector 22 in electrical contact with the cathode 12. The electrolyte layer 10 comprises a composite electrolyte 30, the composite electrolyte containing a porous electrically insulating material having a plurality of pores and a solid electrolyte material covering inner surfaces of the plurality of pores (not illustrated in FIG. 1).

In the example shown in FIG. 1, both the anode 11 and the cathode 12 comprise a plurality of active electrode material particles: active anode material particles 31 and active cathode material particles 32, respectively, shown as open circles in FIG. 1. In the example shown in FIG. 1, the anode 11 and the cathode 12 also contain an electrically conductive additive 40 in the form of particles (shown as filled circles). In the anode 11, openings or spaces are present in the network formed by the active anode material particles 31 and the electrically conductive particles 40. These openings or spaces are filled with a composite electrolyte, preferably the same composite electrolyte 30 as the composite electrolyte forming the electrolyte layer 10. In the cathode 12, openings or spaces are present in the network formed by the active cathode material particles 32 and the electrically conductive particles 40. These openings or spaces are filled with a composite electrolyte, such as the same composite electrolyte 30 as the composite electrolyte forming the electrolyte layer 10.

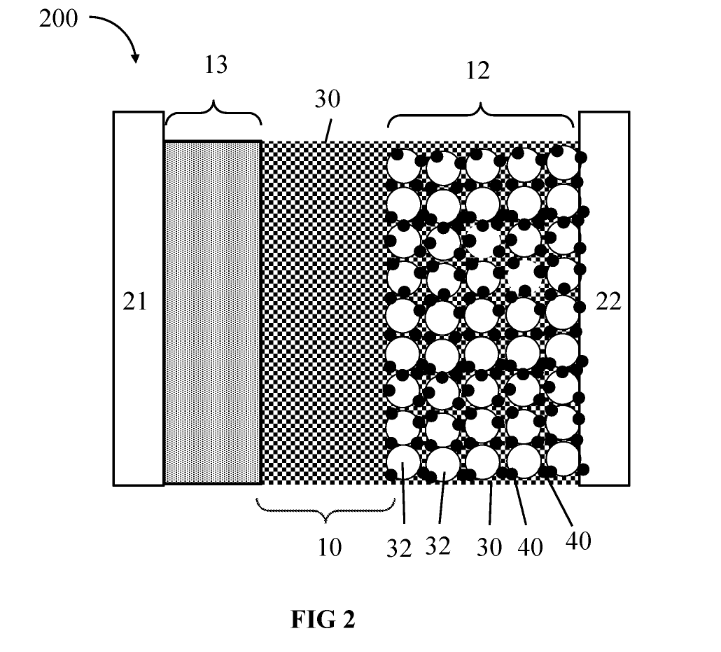

FIG. 2 schematically shows a solid-state battery 200 in accordance with another embodiment of the present disclosure. The solid-state battery 200 comprises a stack of an anode 13, a solid electrolyte layer 10, and a cathode 12. The solid-state battery 200 further comprises a first current collector 21 in electrical contact with the anode 13, and a second current collector 22 in electrical contact with the cathode 12. The solid electrolyte layer 10 comprises a composite electrolyte 30, the composite electrolyte containing a porous electrically insulating material having a plurality of pores and a solid electrolyte material covering inner surfaces of the plurality of pores.

In the example shown in FIG. 2, the anode 13 may for example be a Li metal anode, which can for example be formed by Li deposition (e.g. evaporation or sputtering) or by lamination of a lithium foil. A typical thickness of such Li foil is in the range between 50 micrometer and 60 micrometer, the present disclosure not being limited thereto. The cathode 12 comprises a plurality of active cathode material particles 32, shown as open circles in FIG. 2. In the example shown in FIG. 2, the cathode 12 also contains an electrically conductive additive 40 in the form of particles (shown as filled circles). In the cathode 12, openings or spaces are present in the network formed by the active cathode material particles 32 and the electrically conductive particles 40. These openings or spaces are filled with a composite electrolyte, such as the same composite electrolyte 30 as the composite electrolyte forming the electrolyte layer 10.

It is a potential advantage of a solid-state battery of the present disclosure that it provides a continuous path of ion surface diffusion due to the presence of the composite electrolyte 30 having a continuous porous structure with pores coated with an ionic compound. This results in a good ion conductivity of the electrolyte layer 10, and a good ion conductivity of the composite electrodes 11, 12.

It is another potential advantage of a solid-state battery of the present disclosure that the composite electrolyte 30 is also present in (at least one of) the electrodes, without interruption of the contact between active electrode particles, resulting in a good energy density.

The present disclosure further provides a method for fabricating a composite electrode comprising a plurality of active electrode material particles in electrical contact with each other and comprising a solid composite electrolyte in spaces between the plurality of active electrode material particles, the composite electrolyte containing an electrically insulating material having a plurality of pores and a solid electrolyte material covering inner surfaces of the plurality of pores.

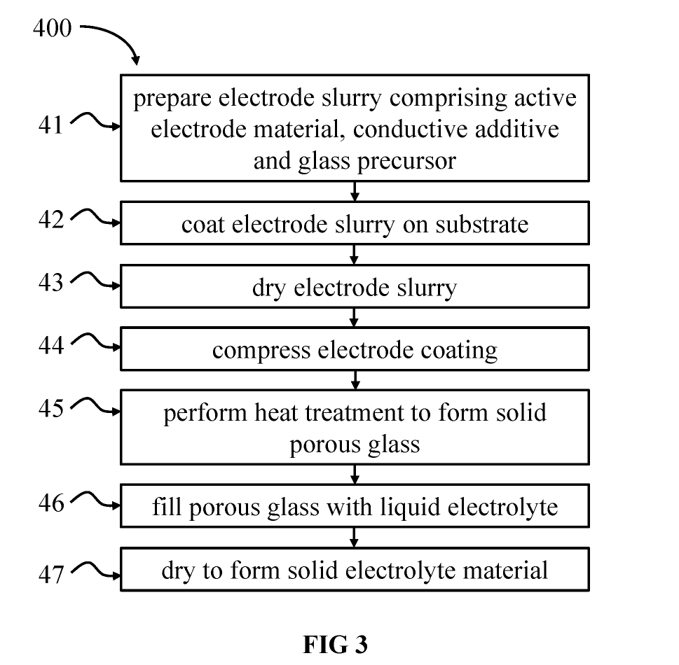

FIG. 3 schematically shows an example of a first method 400 that may be used for fabricating a composite electrode in accordance with the present disclosure, wherein a glass precursor is mixed within an electrode slurry before coating the slurry on a substrate.

According to this method 400, first (block 41) an electrode slurry is prepared by mixing an active electrode material in powder form with a liquid or viscous porous glass precursor (such as a precursor for porous glass, for example Tetraethyl Orthosilicate) and an electrically conductive additive. Optionally a binding agent and/or a surfactant are added to the mixture.

After preparing the electrode slurry, it is coated (block 42) on a substrate, such as for example on an Cu foil (constituting the first current collector) or on an Al foil (constituting the second current collector), the present disclosure not being limited thereto, and dried, e.g. in a vacuum oven at a temperature in the range between 70° C. and 150° C. (block 43). Coating the electrode slurry on the substrate may for example be done by doctor blading, tape casting or dip coating, the present disclosure not being limited thereto. Next, the substrate coated with the electrode material (dried electrode slurry) is compressed (block 44), e.g. using a roll press machine. The compressing process increases the density of the electrode coating and homogenizes the layer thickness. At this point, the electrode coating is still in the form of a gel. By subsequently performing a heat treatment, e.g. in vacuum or at ambient pressure at a temperature in the range between 150° C. and 500° C. (block 45), the glass precursor (which is present in the gel) is transformed into a solid porous glass comprising a plurality of pores.

In a next process (block 46), the porous glass is filled with a liquid electrolyte material, for example containing a lithium salt such as a lithium alkoxide. This may for example be done by a nanocasting method, wherein the liquid electrolyte material is for example dropped onto the porous glass and penetrates into the pores of the porous material. Next, at block 47, a drying process, e.g. in vacuum at a temperature between ambient temperature and 500° C., is performed such that a solid electrolyte material covering inner surfaces of the plurality of pores of the porous glass material is obtained.

In an alternative approach to the method 400 shown in FIG. 3, a liquid electrolyte material, e.g. a lithium salt such as a lithium alkoxide or a gel may be mixed with the other electrode components at the stage of preparing the electrode slurry. In this alternative approach the step of filling the porous glass matrix of the electrode layer with a liquid electrolyte material (block 46) and the subsequent drying step (block 47) may be omitted.

In still another approach to the method 400 shown in FIG. 3, instead of filling the porous glass with a liquid electrolyte material (block 46) and drying (block 47), a solid electrolyte material may be coated on the inner walls or inner surfaces of the plurality of pores by means of a vapor-based process or method, such as CVD (Chemical Vapor Deposition), e.g. ALD (Atomic Layer Deposition).

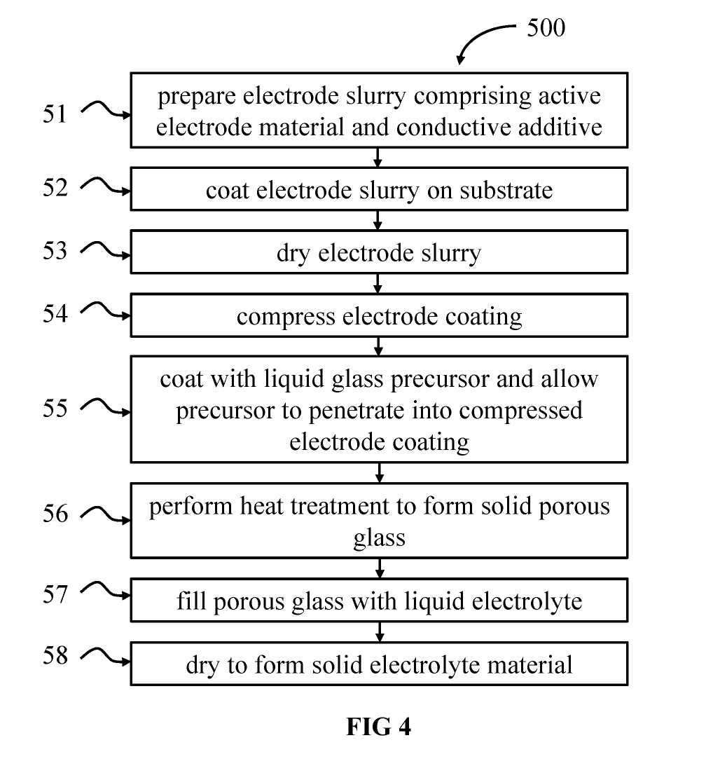

FIG. 4 schematically shows an example of a second method 500 that may be used for fabricating a composite electrode in accordance with the present disclosure, wherein the glass precursor is provided after the process of compressing the electrode coating.

In this method 500, in a first step (block 51) an electrode slurry is prepared by dispersing and mixing an active electrode material powder, an electrically conductive additive, and optionally a binding agent in a solvent such as for example N-methyl-2-pyrrolidone (NMP). This slurry is coated on a substrate (block 52), such as for example on a Cu foil or on an Al foil, and the slurry is dried (block 53), e.g. by exposure to hot air, for example at a temperature in the range between 70° C. and 150° C. Coating the electrode slurry on the substrate may for example be done by doctor blading, tape casting, or dip coating. Next the substrate coated with the electrode coating (dried electrode slurry) is compressed (block 54), e.g. using a roll press machine. The compressing process increases the density of the electrode coating and homogenizes the layer thickness. In a next step (block 55) a liquid glass precursor is provided on top of the compressed electrode coating, e.g. by doctor blading, tape casting, or dip coating, and allowed to penetrate into the compressed electrode coating and to fill (at least partially) openings or spaces that are present in the compressed electrode coating.

At this point, the electrode material is still in the form of a gel. By subsequently performing a heat treatment at a temperature in the range between 150° C. and 500° C. (block 56), the glass precursor (which is present in the gel) is transformed into a solid porous electrically insulating (e.g. glass) material having a plurality of pores.

In a next process (block 57), the porous glass of the electrode layer is filled at least partially with a liquid electrolyte material, for example containing a lithium salt such as a lithium alkoxide. This may for example be done by a nanocasting method. Next, at block 58, a drying process is performed such that a solid electrolyte material covering inner surfaces of the pores of the glass material is obtained.

In an alternative approach to this method 500, a liquid electrolyte material, e.g. a lithium salt such as a lithium alkoxide or a gel may be mixed with the liquid glass precursor before providing it on the layer of electrode material at block 55. In this alternative approach, the process of filling the porous glass of the electrode layer with a liquid electrolyte material (block 57) and the subsequent drying process (block 58) may be omitted.

In still another approach to the method 500 shown in FIG. 4, instead of filling the porous glass with a liquid electrolyte material (block 57) and drying (block 58), a solid electrolyte material may be coated on the inner walls or inner surfaces of the plurality of pores by means of a vapor-based method or process, such as CVD (Chemical Vapor Deposition), e.g. ALD (Atomic Layer Deposition).

The present disclosure further provides a method for fabricating a solid-state battery comprising a stack of an anode, a composite electrolyte layer, and a cathode. In one example, the composite electrolyte layer comprises a porous electrically insulating material having a plurality of pores and a solid electrolyte material covering inner surfaces of the plurality of pores. Further, in this example, at least one of the anode and the cathode is a composite electrode comprising a plurality of active electrode material particles in electrical contact with each other and the composite electrolyte in openings or spaces between the particles.

A fabrication method for a solid-state battery in accordance with the present disclosure may be performed at temperatures not exceeding 500° C. The fabrication method may comprise roll-to-roll processing. The fabrication method may consist of roll-to-roll processing.

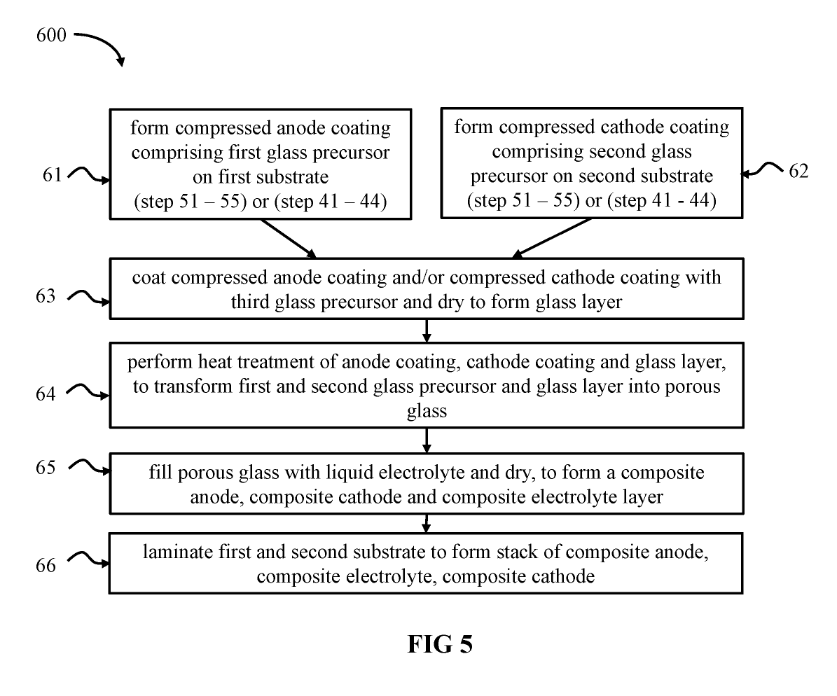

FIG. 5 shows an example of a process flow 600 that may be used for fabricating a solid-state battery cell according to the present disclosure.

According to this method 600, a compressed anode coating comprising a plurality of active anode material particles and comprising a first glass precursor is formed on a first substrate (block 61). The compressed anode coating may for example be formed according to block 41 to block 44 of method 400 (FIG. 3), or according to block 51 to block 55 of method 500 (FIG. 4). The first substrate may for example be a foil, e.g. a metal foil such as copper foil, or a plastic foil laminated or coated with a metal layer such as a copper layer.

On a second substrate, a compressed cathode coating is formed, the compressed cathode coating comprising a plurality of active cathode material particles and a second glass precursor (block 62). The compressed cathode coating may for example be formed according to block 41 to block 44 of method 400 (FIG. 3), or according to block 51 to block 55 of method 500 (FIG. 4). The second substrate may for example be a foil, e.g. a metal foil such as an aluminum foil, or a plastic foil laminated or coated with a metal layer such as an aluminum layer.

The first substrate and/or the second substrate may have the function of a current collector in the solid-state battery cell.

Next, at block 63, a third glass precursor is coated, e.g. casted, on top of at least one of the compressed cathode coating and the compressed anode coating. The third glass precursor is then dried, e.g. at a temperature in the range between 70° C. and 150° C., to form a glass layer. This drying process is performed at a temperature lower than a temperature where pore formation occurs (which is typically in the range between 150° C. and 500° C.). Therefore, after this drying process there is no pore formation yet, i.e. the glass layer is a substantially non-porous glass layer.

The compressed anode coating, the compressed cathode coating, and the glass layer are then heated to a temperature in the range between 150° C. and 500° C., thereby transforming the first glass precursor (present in the compressed anode coating), the second glass precursor (present in the compressed cathode coating), and the (non-porous) glass layer into a solid porous material comprising a plurality of pores (block 64).

The porous structures (resulting from the first glass precursor, the second glass precursor, and the third glass precursor) are then filled (block 65) at least partially with a liquid electrolyte material such as e.g. a lithium salt by a nanocasting method or a similar method such as tape casting or dip coating, and dried (block 65), thereby transforming the liquid electrolyte material into a solid electrolyte material covering inner surfaces of the plurality of pores, and forming a composite anode, a composite cathode, and a composite electrolyte layer. Alternatively, a solid electrolyte material may be provided on the inner surfaces of the plurality of pores by means of a vapor-based process as described above.

After having formed the composite cathode and the composite anode, both foils, i.e. the foil coated with the cathode and the foil coated with the anode, are laminated together, optionally with a thin glue layer (having a thickness e.g. in the range between 100 nm and 10 micrometer) in between. The thin glue layer may for example comprise a porous glass, an ion-conducting polymer, a lithium salt solution, an ion conducting gel, or a combination thereof (block 66). During lamination, a pressure can be applied or the structure may be heated or both pressure and heating may be used.

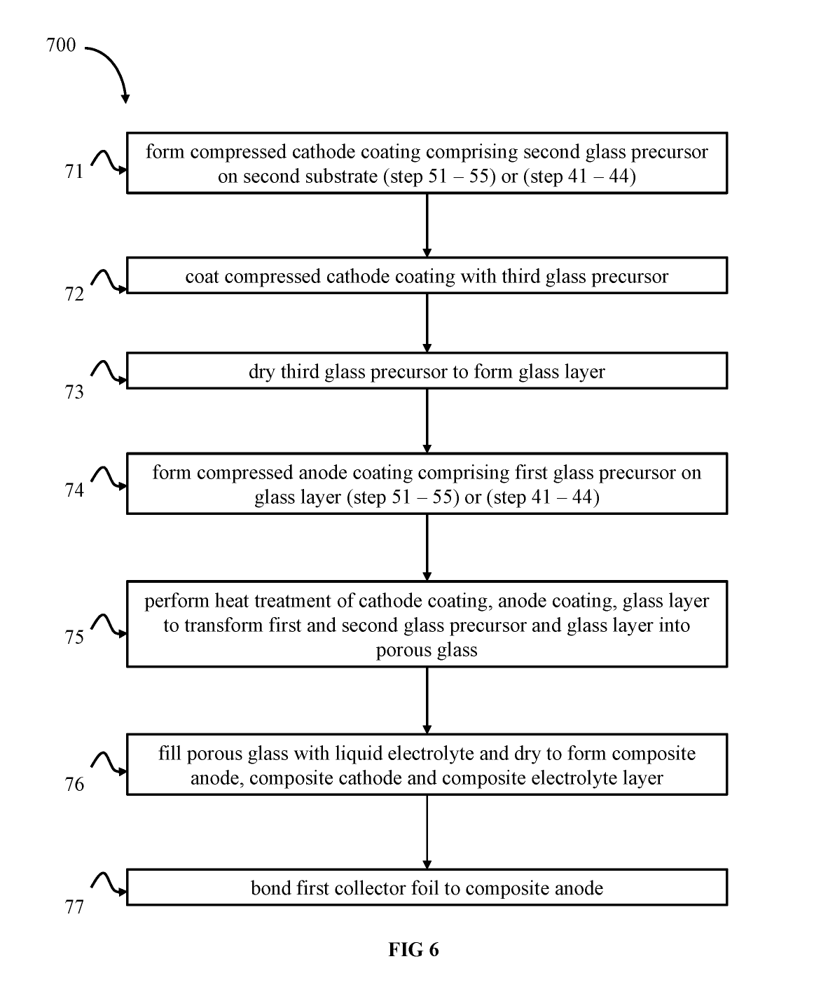

FIG. 6 shows another example of a process flow 600 that may be used for fabricating a solid-state battery according to the present disclosure.

First, a compressed cathode coating is formed on a second substrate, e.g. second foil, that may function as a second electrode collector in the battery cell (FIG. 6, block 71). The compressed cathode coating comprises a plurality of active cathode material particles and a second glass precursor. It may for example be formed according to block 41 to block 44 of method 400 (FIG. 3), or according to block 51 to block 55 of method 500 (FIG. 4). For example, a mixture comprising an electrode powder material such as for example LMO (lithium manganese oxide) powder, CNT (carbon nanotube) powder and optionally additives such as binders (binding agents) and a solvent such as NMP, is prepared (e.g. according to FIG. 4, block 51). It is coated (FIG. 4, block 52), dried (FIG. 4, block 53) and pressed (FIG. 4, block 54) on a metal foil, e.g. a 60 micrometer thick Al foil (second substrate, constituting the second current collector). Drying may for example be done in vacuum at a temperature in the range from 70° C. to 150° C. The resulting cathode coating may for example have a thickness in the range between 50 micrometer and 200 micrometer. In a next process (FIG. 4, block 55), a liquid glass precursor (e.g. TEOS with organic copolymers) is slowly poured onto the compressed cathode coating (which may e.g. be placed inside a mold to prevent spilling of the liquid) and allowed to penetrate into openings or spaces in between the powder pellets of the compressed layer. Vacuum suction can be used to remove trapped air or gas bubbles. The pellets with glass precursor may then be cured at a temperature e.g. in the range between 70° C. and 150° C. to form a solid glass without removal of the surfactant and thus without pore formation. The coating may be polished to smooth the electrode surface.

Next (FIG. 6, block 72) a third glass precursor may be provided on the compressed cathode coating, e.g. by spin coating, doctor blading, tape coating or dip coating. This third glass precursor layer is dried or cured (FIG. 6, block 73) at a temperature e.g. in the range between 70° C. and 150° C. to form a glass layer. These processes (block 72 and block 73) may be repeated until a glass layer having a predetermined thickness (for example a thickness in the range between 20 nm and 100 micrometer, e.g. in the range between 100 nm and 1 micrometer) is obtained. After the drying step there is no pore formation yet, i.e. the glass layer is a substantially non-porous glass layer.

Afterwards a compressed anode coating comprising a plurality of active anode particles and comprising a first glass precursor is provided on the glass layer (FIG. 6, block 74). The compressed anode coating may for example be formed using a method according to block 41 to block 44 (FIG. 3), or a method according to block 51 to block 55 (FIG. 4). For example, for forming the anode coating a mixture comprising an electrode powder material such as for example LTO (lithium titanate) powder, CNT powder, and optionally additives such as binders, is prepared (FIG. 4, block 5). It is coated on top of the glass layer (FIG. 4, block 52), dried (FIG. 4, block 53), and compressed (FIG. 4, block 54). Drying may for example be done in vacuum at a temperature in the range between 70° C. and 150° C. Next, a liquid glass precursor is dropped onto the compressed anode coating and allowed to fill at least partially spaces between pellets of the compressed anode layer (FIG. 4, block 55). It may then be cured at a temperature e.g. in the range between 70° C. and 150° C. to form a solid glass without removal of the surfactant and thus without pore formation. After curing, the foil/cathode/glass/anode stack may be polished to remove excess glass and to smoothen the anode surface.

Next (FIG. 6, block 75), the stack comprising the compressed cathode coating, the glass layer and the compressed anode coating is heat treated at a temperature in the range between 150° C. and 500° C., to remove the surfactant, thereby transforming the first glass precursor, the second glass precursor and the glass layer into a solid porous material comprising a plurality of pores. Depending on the thickness and size of the battery stack, this process may take a few hours up to 48 hours.

The porous glass material is then functionalized with an electrolyte material, e.g. a lithium salt such as LiPO₄, LiCO₃ or Lil (FIG. 6, block 76). The plurality of pores of the porous glass material (present in the anode, the cathode and the glass layer) are at least partially filled with the liquid electrolyte material, and the liquid electrolyte material is dried to form a solid electrolyte material covering inner surfaces of the plurality of pores. Alternatively, a solid electrolyte material may be provided on the inner surfaces of the plurality of pores by means of a vapor-based method as described above. In this way a composite anode, a composite electrolyte layer and a composite cathode in accordance with the present disclosure are formed.

Next, block 77, a first electrode collector foil (e.g. a copper foil or a foil containing a copper layer) is bonded to the composite anode, e.g. by pressing. The anode surface may receive a slight polish first to clean the surface. Conductive binders such as Ag paint or acetylene black may be used between the Cu and the anode surface to assure good electrical contact between the Cu and the anode.

The foregoing description details certain embodiments of the disclosure. It will be appreciated, however, that no matter how detailed the foregoing appears in text, the disclosure may be practiced in many ways. It should be noted that the use of particular terminology when describing certain features or aspects of the disclosure should not be taken to imply that the terminology is being re-defined herein to be restricted to including any specific characteristics of the features or aspects of the disclosure with which that terminology is associated.

While the above detailed description has shown, described, and pointed out novel features of the invention as applied to various embodiments, it will be understood that various omissions, substitutions, and changes in the form and details of the device or process illustrated may be made by those skilled in the technology without departing from the invention.

What is claimed is:

1. A composite electrode comprising:
an active electrode material; and
a solid electrolyte, wherein the solid electrolyte is a composite electrolyte.

2. The composite electrode according to claim 1, wherein the composite electrolyte comprises:
an electrically insulating material having a plurality of pores; and
a solid electrolyte material covering inner surfaces of the plurality of pores.

3. The composite electrode according to claim 2, wherein the solid electrolyte material covering inner surfaces of the plurality of pores is an inorganic electrolyte material comprising a salt.

4. The composite electrode according to claim 2, wherein the solid electrolyte material covering inner surfaces of the plurality of pores is a polymer electrolyte material comprising an insulating polymer and a salt.

5. The composite electrode according to claim 1, wherein the active electrode material comprises a plurality of active electrode material particles in electrical contact with each other, and wherein the composite electrolyte is located in spaces between the plurality of active electrode material particles.

6. The composite electrode according to claim 1, further comprising an electrically conductive additive.

7. A solid-state battery comprising a stack of an anode, a solid electrolyte layer and a cathode, wherein at least one of the anode and the cathode is a composite electrode according to claim 1.

8. The solid-state battery according to claim 7, wherein the solid electrolyte layer comprises a composite electrolyte comprising:
an electrically insulating material having a plurality of pores; and
a solid electrolyte material covering inner surfaces of the plurality of pores.

9. The solid-state battery according to claim 8, wherein the composite electrode and the solid electrolyte layer comprise a same composite electrolyte.

10. The solid-state battery according to claim 7, further comprising a first current collector in electrical contact with the anode, and a second current collector in electrical contact with the cathode.

11. A method for fabricating a composite electrode, the method comprising:
preparing an electrode slurry comprising a plurality of active electrode material particles and an electrically conductive additive;
coating the electrode slurry on a substrate;
drying the electrode slurry, thereby forming an electrode coating;
compressing the electrode coating, thereby forming a compressed electrode coating;
providing a liquid or viscous glass precursor in the compressed electrode coating; and
performing a heat treatment, thereby transforming the glass precursor into a solid porous electrically insulating material comprising a plurality of pores.

12. The method according to claim 11, wherein providing the liquid or viscous glass precursor in the compressed electrode coating comprises providing the glass precursor in the electrode slurry before coating the electrode slurry on the substrate.

13. The method according to claim 11, wherein providing the liquid or viscous glass precursor in the compressed electrode coating comprises:
coating the glass precursor on the compressed electrode coating; and
allowing the glass precursor to penetrate into the compressed electrode coating, thereby filling spaces between the plurality of active electrode material particles.

14. The method according to claim 11, further comprising providing a solid electrolyte material covering inner surfaces of the plurality of pores.

15. The method according to claim 14, wherein providing the solid electrolyte material comprises:
filling the plurality of pores of the porous electrically insulating material at least partially with a liquid electrolyte material; and
performing a drying step, thereby forming a solid electrolyte material covering inner surfaces of the plurality of pores.

16. The method according to claim 14, wherein providing the solid electrolyte material comprises coating the electrolyte material on the inner surfaces of the plurality of pores by a vapor-based process.

17. The method according to claim 11, further comprising mixing the glass precursor with a liquid electrolyte material before performing the heat treatment.

18. A method for fabricating a solid-state battery, the method comprising:
forming on a first substrate a compressed anode coating comprising a plurality of active anode material particles, an electrically conductive additive, and a first glass precursor;
forming on a second substrate a compressed cathode coating comprising a plurality of active cathode material particles, an electrically conductive additive, and a second glass precursor;
providing a third glass precursor on at least one of the compressed anode coating or the compressed cathode coating;
drying the third glass precursor at a temperature in the range between 70° C. and 150° C., thereby forming a glass layer having a predetermined thickness;
heating the compressed anode coating, the compressed cathode coating, and the glass layer to a temperature in the range between 150° C. and 500° C., thereby transforming the first glass precursor, the second glass precursor, and the glass layer into solid porous materials comprising a plurality of pores; and
providing a solid electrolyte material covering inner surfaces of the plurality of pores, thereby forming a composite cathode, a composite electrolyte layer, and a composite anode.

19. The method according to claim 18, further comprising laminating the first substrate comprising the composite anode to the second substrate comprising the composite cathode, thereby forming a stack of a composite anode, a composite electrolyte, and a composite cathode.

20. The method according to claim 18, wherein providing the third glass precursor comprises providing the third glass precursor on the compressed cathode coating, and wherein forming the compressed anode coating on the first substrate comprises forming the compressed anode coating on the glass layer.
